(19) United States
(12) Patent Application Publication
(10) Pub. No.: US 2017/0315807 A1
(43) Pub. Date: Nov. 2, 2017

(54) HARDWARE SUPPORT FOR DYNAMIC DATA TYPES AND OPERATORS

(71) Applicant: Oracle International Corporation, Redwood City, CA (US)

(72) Inventors: Jeffrey Diamond, Austin, TX (US); Herbert Schwetman, Austin, TX (US); Avadh Patel, Cedar Park, TX (US)

(21) Appl. No.: 15/143,753

(22) Filed: May 2, 2016

(51) Int. Cl. G06F 9/30; G06F 9/38

(52) U.S. Cl. CPC G06F 9/3016; G06F 9/30181; G06F 9/3802

(57) ABSTRACT

A decoder circuit may be configured to receive an instruction which includes a plurality of data bits and decode a first subset of the plurality of data bits. A transcode circuit may be configured to determine if the received instruction is to be modified and, in response to a determination that the received instruction is to be modified, modify a second subset of the plurality of data bits.

### BACKGROUND

### Technical Field

Embodiments described herein relate to integrated circuits, and more particularly, to techniques for decoding fetched instructions.

### Description of the Related Art

Computing systems typically include one or more processors or processing cores which are configured to execute program instructions. The program instructions may be stored in one of various locations within a computing system, such as, e.g., main memory, a hard drive, a CD-ROM, and the like.

Processors include various circuit blocks, each with a dedicated task. For example, a processor may include an instruction fetch unit, a memory management unit, and an arithmetic logic unit (ALU). An instruction fetch unit may prepare program instruction for execution by decoding the program instructions and checking for scheduling hazards, while arithmetic operations such as addition, subtraction, and Boolean operations (e.g., AND, OR, etc.) may be performed by an ALU. Some processors include high-speed memory (commonly referred to as “cache memories” or “caches”) used for storing frequently used instructions or data

In the program instructions, multiple variables may be employed. Such variables may be set to different values during execution. In some programming languages, variables may be defined as a particular type (commonly referred to as a “data type”) that indicates a type of data a given variable should store. For example, in some cases, a variable may be declared as an integer, a real, a Boolean, and the like.

### SUMMARY OF THE EMBODIMENTS

Various embodiments of an instruction pipeline are disclosed. Broadly speaking, a circuit and a method are contemplated in which a decoder circuit may be configured to receive an instruction that includes a plurality of data bits and decode a first subset of the plurality of data bits. A transcode circuit may be configured to determine if the instruction is to be modified and, in response to a determination that the instruction is to be modified, modify a second subset of the plurality of data bits.

In one embodiment, the second subset of the plurality of data bits includes information indicative of a type of an operand associated with the instruction. In another non-limiting embodiments, the second subset of the plurality of data bits includes information indicative of an operator associated with the instruction.

In a further embodiment, the transcode circuit may include a register. To modify the second subset of the plurality of data bits, the transcode unit may be further configured to read data from the included register.

### BRIEF DESCRIPTION OF THE DRAWINGS

The following detailed description makes reference to the accompanying drawings, which are now briefly described.

FIG. 1 illustrates an embodiment of a computing system.

FIG. 2 illustrates an embodiment of a processor.

FIG. 3 illustrates an embodiment Dynamic Instruction Transcode Unit.

FIG. 4 illustrates a chart of an embodiment of dynamic types and operations encoding.

FIG. 5 depicts flow diagram illustrating an embodiment of a method for providing hardware support for dynamic data types.

FIG. 6 depicts a flow diagram illustrating an embodiment of a method adding a prefix instruction.

FIG. 7 depicts a flow diagram illustrating an embodiment of a single instruction method for supporting dynamic data types.

FIG. 8 illustrates a block diagram depicting high-level language support for dynamic data types.

While the disclosure is susceptible to various modifications and alternative forms, specific embodiments thereof are shown by way of example in the drawings and will herein be described in detail. It should be understood, however, that the drawings and detailed description thereto are not intended to limit the disclosure to the particular form illustrated, but on the contrary, the intention is to cover all modifications, equivalents and alternatives falling within the spirit and scope of the present disclosure as defined by the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include,” “including,” and “includes” mean including, but not limited to.

### DETAILED DESCRIPTION OF EMBODIMENTS

Some software platforms may execute code in which data types and operators may vary during runtime. Modern processors may lack circuitry to support such variations in data types and operators, resulting in software-only solutions. Such software-only solutions may result in the execution of many additional program instructions, as well as an undesirable number of cache misses, each of which may contribute to reduced performance. The embodiments illustrated in the drawings and described below may provide techniques providing hardware support for dynamic data types and operators while mitigating performance reductions.

Various application categories may involve executing a particular function on arbitrary data types or operator categories during runtime. For example, a Structure Query Language (SQL) engine executing a FILTER command on a column of data may apply a test to each element included in the column to determine a type associate with the element. In some cases, however, the elements included in the column may be of a variety of data types. For example, an element may be a signed or unsigned integer, or the element may be of different sizes (e.g., 1, 2, 4, or 8-bytes).

A possible method to handle the data type determination is to employ a large, nested switch statement based on the data type and a comparison. Such data dependent branching may result in cache misses, and undesirable performance in a deeply pipelined processor or processor core. To maintain performance, the entire inner loop must be replicated in the code along each variant of the filter function. An example of such code replication is depicted in Program Code Example 1.

### Program Code Example 1

```
//########################################
Perform Filter - Pseudocode - cases reduced for illustration
//########################################
Collapse cases where possible, e.g.:
  if operation is FilterIntGE −> compare−, operation =
FilterIntGT...
if operation is FilterIntLE −> compare++, operation =FilterIntLT...
etc...
Promote comparison scalar to most general compatible type, e.g.
64-bit unsigned
Handle unsigned comparisons (pseudocode)...
  if not signed integer compare...
choose code based on key column's width:
if width is 1, it's a category...
```

...then choose code based on operation:

if operation is FilterEQ...

Perform simple filter code for this data type:

if operation is FilterLT...

Perform simple filter code for this data type:

if operation is FilterGT...

Perform simple filter code for this data type:

else if width is 2, it's a date...

...then choose code based on operation:

if operation is FilterEQ...

Perform simple filter code for this data type:

if operation is FilterLT...

Perform simple filter code for this data type:

if operation is FilterGT...

Perform simple filter code for this data type:

else if width is 4, it's positive currency...

...then choose code based on operation:

if operation is FilterEQ...

Perform simple filter code for this data type:

if operation is FilterLT...

Perform simple filter code for this data type:

if operation is FilterGT...

Perform simple filter code for this data type:

else if width is 8, it's a unique ID...

...then choose code based on operation:

if operation is FilterEQ...

Perform simple filter code for this data type:

if operation is FilterLT...

Perform simple filter code for this data type:

if operation is FilterGT...

Perform simple filter code for this data type:

else print ERROR - DATA TYPE NOT HANDLED!
else if signed integer compare...
Handle signed comparisons (pseudocode)...
choose code based on key column's width:
if width is 1, it's a signed category...

...then choose code based on operation:

if operation is FilterEQ...

Perform simple filter code for this data type:

if operation is FilterLT...

Perform simple filter code for this data type:

if operation is FilterGT...

Perform simple filter code for this data type:

else if width is 2, it's a signed (relative) date...

...then choose code based on operation:

if operation is FilterEQ...

Perform simple filter code for this data type:

if operation is FilterLT...

Perform simple filter code for this data type:

if operation is FilterGT...

Perform simple filter code for this data type:

else if width is 4, it's signed currency, such as a balance...

...then choose code based on operation:

if operation is FilterEQ...

Perform simple filter code for this data type:

if operation is FilterLT...

Perform simple filter code for this data type:

if operation is FilterGT...

Perform simple filter code for this data type:

else if width is 8, it's a large signed value, such as an index
code...

...then choose code based on operation:

if operation is FilterEQ...

Perform simple filter code for this data type:

if operation is FilterLT...

Perform simple filter code for this data type:

if operation is FilterGT...

Perform simple filter code for this data type:

else print ERROR - DATA TYPE NOT HANDLED!
else print ERROR - DATA TYPE CATEGORY NOT HANDLED!

Complicate code, such as illustrated in Program Code Example 1, is difficult to maintain and may reduce overall system performance. Additionally, executing each line of code results in a corresponding power dissipation. The more lines of code executed, the greater the power dissipation.

A possible solution to the problem may involve significant changes to both the circuitry of a processor or a processor core as well as the Instruction Set Architecture for the processor or processor core. If, however, some circuitry is added to the processor or processor core that allows for the modification of instructions at the front-end of the processor or processor core, functions that allow for arbitrary data types and operators may be realized with minimal impact on the existing hardware and Instruction Set Architecture. As described below in more detail, the additional circuitry to support the modification of instructions at the front-end of a processor or processor core, may result in a significant reduction in a number of lines of code. Program Code Example 2 illustrates such a reduction as the filter depicted in Program Code Example 1 has been reduced to single for-loop.

### Program Code Example 2

//########################################
With hardware support for Dynamic Types...
//########################################
//########################################
Execute SINGLE copy of loop code for all cases and no performance
hit
//########################################
//
for each Element in column: // This becomes a single assembly
instruction!
if match(Element, value, compare_operation) then save match

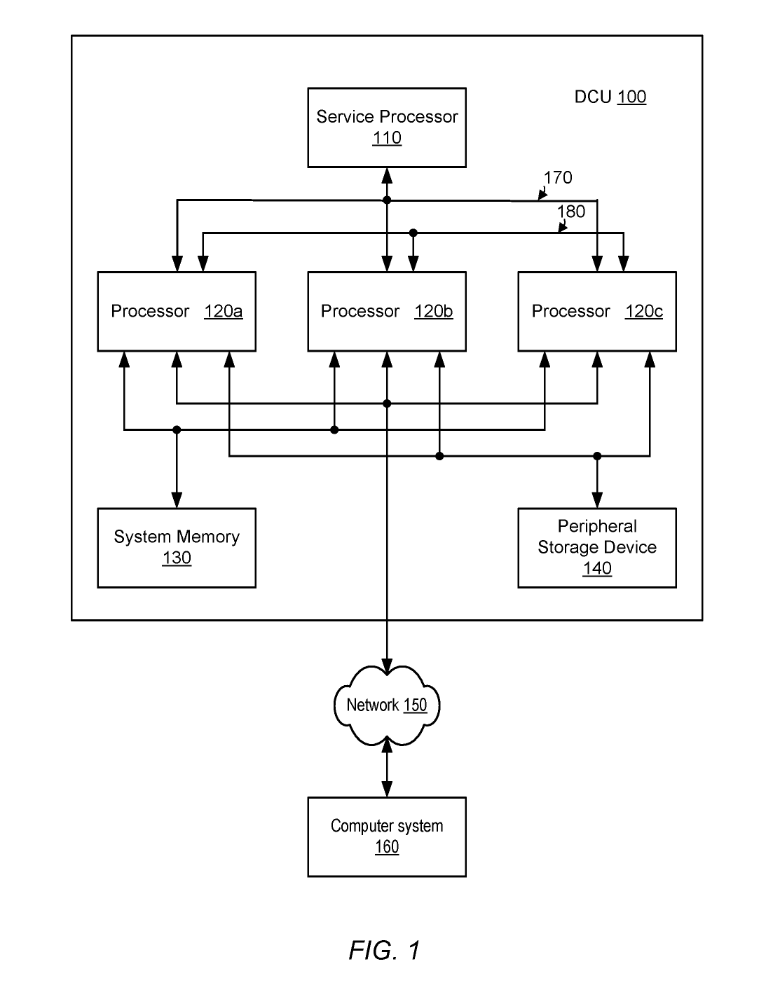

A block diagram illustrating one embodiment of a computing system that includes a distributed computing unit (DCU) is shown in FIG. 1. In the illustrated embodiment, DCU 100 includes a service processor 110, coupled to a plurality of processors 120a-c through bus 170. It is noted that in some embodiments, system processor 110 may additionally be coupled to system memory 130 through bus 170. Processors 120a-c are, in turn, coupled to system memory 130, and peripheral storage device 140. Processors 120a-c are further coupled to each other through bus 180 (also referred to herein as “coherent interconnect 180”). DCU 100 is coupled to a network 150, which is, in turn coupled to a computer system 160. In various embodiments, DCU 100 may be configured as a rack-mountable server system, a standalone system, or in any suitable form factor. In some embodiments, DCU 100 may be configured as a client system rather than a server system.

System memory 130 may include any suitable type of memory, such as Fully Buffered Dual Inline Memory Module (FB-DIMM), Double Data Rate, Double Data Rate 2, Double Data Rate 3, or Double Data Rate 4 Synchronous Dynamic Random Access Memory (DDR/DDR2/DDR3/DDR4 SDRAM), or Rambus® DRAM (RDRAM®), for example. It is noted that although one system memory is shown, in various embodiments, any suitable number of system memories may be employed.

Peripheral storage device 140 may, in some embodiments, include magnetic, optical, or solid-state storage media such as hard drives, optical disks, non-volatile random-access memory devices, etc. In other embodiments, peripheral storage device 140 may include more complex storage devices such as disk arrays or storage area networks (SANs), which may be coupled to processors 120a-c via a standard Small Computer System Interface (SCSI), a Fiber Channel interface, a Firewire® (IEEE 1394) interface, or another suitable interface. Additionally, it is contemplated that in other embodiments, any other suitable peripheral devices may be coupled to processors 120a-c, such as multi-media devices, graphics/display devices, standard input/output devices, etc.

In one embodiment, service processor 110 may include a field programmable gate array (FPGA) or an application specific integrated circuit (ASIC) configured to coordinate initialization and boot of processors 120a-c, such as from a power-on reset state.

As described in greater detail below, each of processors 120a-c may include one or more processor cores and cache memories. In some embodiments, each of processors 120a-c may be coupled to a corresponding system memory, while in other embodiments, processors 120a-c may share a common system memory. Processors 120a-c may be configured to work concurrently on a single computing task and may communicate with each other through coherent interconnect 180 to coordinate processing on that task. For example, a computing task may be divided into three parts and each part may be assigned to one of processors 120a-c. Alternatively, processors 120a-c may be configured to concurrently perform independent tasks that require little or no coordination among processors 120a-c.

The embodiment of the distributed computing system illustrated in FIG. 1 is one of several examples. In other embodiments, different numbers and configurations of components are possible and contemplated. It is noted that although FIG. 1 depicts a multi-processor system, the embodiments described herein may be employed with any number of processors, including a single processor core

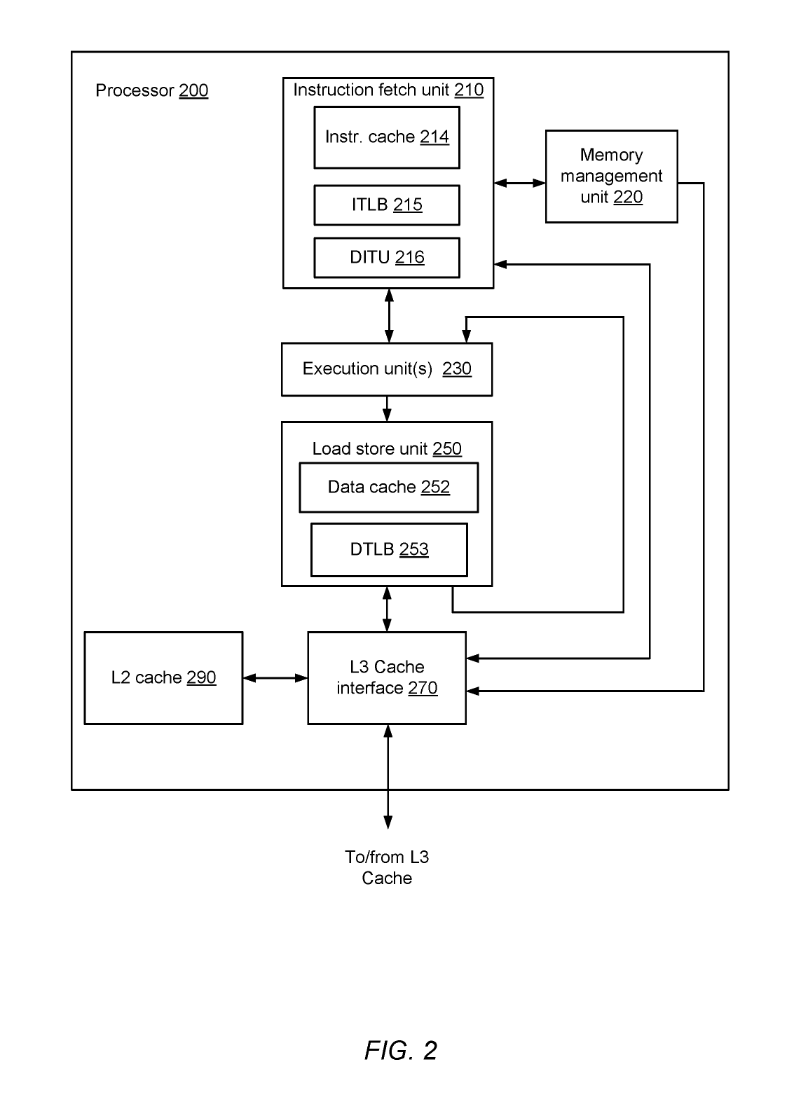

A possible embodiment of processor is illustrated in FIG. 2. In the illustrated embodiment, processor 200 includes an instruction fetch unit (IFU) 210 coupled to a memory management unit (MMU) 220, a L3 cache interface 270, a L2 cache memory 290, and one or more of execution units 230. Execution unit(s) 230 is coupled to load store unit (LSU) 250, which is also coupled to send data back to each of execution unit(s) 230. Additionally, LSU 250 is coupled to L3 cache interface 270, which may in turn be coupled a L3 cache memory.

Instruction fetch unit 210 may be configured to provide instructions to the rest of processor 200 for execution. In the illustrated embodiment, IFU 210 may be configured to perform various operations relating to the fetching of instructions from cache or memory, the selection of instructions from various threads for execution, and the decoding of such instructions prior to issuing the instructions to various functional units for execution. Instruction fetch unit 210 further includes an instruction cache 214. In one embodiment, IFU 210 may include logic to maintain fetch addresses (e.g., derived from program counters) corresponding to each thread being executed by processor 200, and to coordinate the retrieval of instructions from instruction cache 214 according to those fetch addresses.

In one embodiment, IFU 210 may be configured to maintain a pool of fetched, ready-for-issue instructions drawn from among each of the threads being executed by processor 200. For example, IFU 210 may implement a respective instruction buffer corresponding to each thread in which several recently-fetched instructions from the corresponding thread may be stored. In some embodiments, IFU 210 may be configured to select multiple ready-to-issue instructions and concurrently issue the selected instructions to various functional units without constraining the threads from which the issued instructions are selected. In other embodiments, thread-based constraints may be employed to simplify the selection of instructions. For example, threads may be assigned to thread groups for which instruction selection is performed independently (e.g., by selecting a certain number of instructions per thread group without regard to other thread groups).

In some embodiments, IFU 210 may be configured to further prepare instructions for execution, for example by decoding instructions, detecting scheduling hazards, arbitrating for access to contended resources, or the like. Moreover, in some embodiments, instructions from a given thread may be speculatively issued from IFU 210 for execution. Additionally, in some embodiments IFU 210 may include a portion of a map of virtual instruction addresses to physical addresses. The portion of the map may be stored in Instruction Translation Lookaside Buffer (ITLB) 215.

Additionally, IFU 210 includes Dynamic Instruction Transcode Unit (DITU), which may be configured to modify fetched instructions at the front-end of the processor 200. As described below in more detail, the addition of DITU into processor 200 may, in various embodiments, provide hardware support for dynamic data types and operators while mitigating performance reductions in processor 200. By modifying instructions at the front-end of processor 200, DITU 216 may support the use of dynamic types and operators, thereby expanding the abilities of a particular Instruction Set Architecture. As described below in more detail, DITU 216 may include decoders, registers, and a transcode unit, all of which may be employed to detect instructions to be modified and then perform any modifications on the data bit fields included instructions to be modified.

Execution unit 230 may be configured to execute and provide results for certain types of instructions issued from IFU 210. In one embodiment, execution unit 230 may be configured to execute certain integer-type instructions defined in the implemented ISA, such as arithmetic, logical, and shift instructions. It is contemplated that in some embodiments, processor 200 may include more than one execution unit 230, and each of the execution units may or may not be symmetric in functionality.

Load store unit 250 may be configured to process data memory references, such as integer and floating-point load and store instructions. In some embodiments, LSU 250 may also be configured to assist in the processing of instruction cache 214 misses originating from IFU 210. LSU 250 may include a data cache 252 as well as logic configured to detect cache misses and to responsively request data from L2 cache 290 or a L3 cache partition via L3 cache partition interface 270. Additionally, in some embodiments LSU 350 may include logic configured to translate virtual data addresses generated by EXUs 230 to physical addresses, such as Data Translation Lookaside Buffer (DTLB) 253.

It is noted that the embodiment of a processor illustrated in FIG. 2 is merely an example. In other embodiments, different functional block or configurations of functional blocks are possible and contemplated.

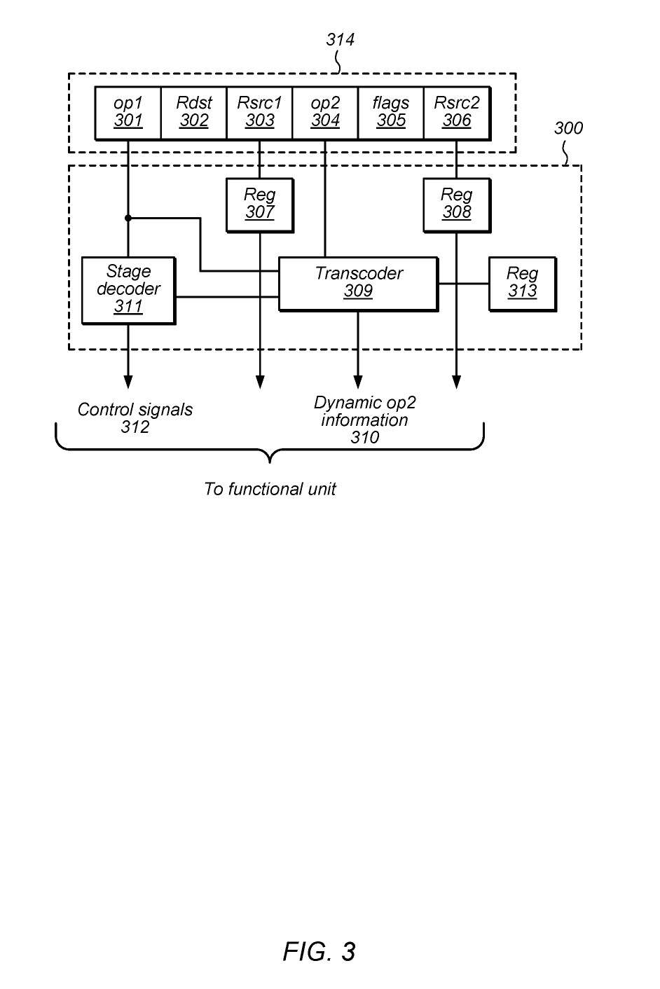

Turning to FIG. 3, a block diagram of an embodiment of a Dynamic Instruction Transcode Unit (DITU) is illustrated. In various embodiments, DITU 300 may correspond to DITU 216 as illustrated in the embodiment of FIG. 2. In the illustrated embodiment, DITU 300 includes Stage decoder 311, registers Reg 307, Reg 308, and Reg 313, and Transcoder 309.

Each of registers Reg 307, Reg 308, and Reg 313 may be designed according to one of various design styles. In some embodiments, the aforementioned registers may include multiple data storage circuits, each of which may be configured to store a single data bit. Such storage circuits may be dynamic, static, or any other suitable type of storage circuit.

During operation, DITU 300 may receive fetched instruction 314. Fetched instruction 314 may include multiple data bit fields. In the present embodiment, fetched instruction 314 includes op1 301, Rdst 302, Rsrc1 303, op2 304, flags 305, and Rscr2 306. Each of these data bits fields may correspond to specific portions of the fetched instruction. For example, opt 301 and op2 304 may specify a type of respective operands, while Rdst 302 may specify a destination register into which a result of the desired operation is stored.

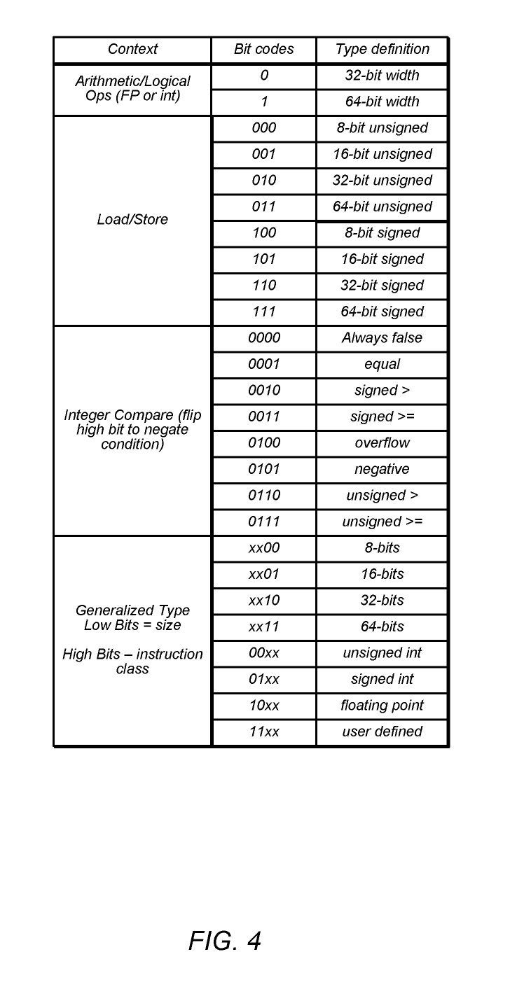

As mentioned above, some of the data bits fields included in fetched instruction 314 may encode types and operators according to a particular Instruction Set Architecture (ISA). Such encoding are typically compact, using 1 to 4 data bits. As shown in FIG. 4, each instruction class, such as, e.g., Load/Store, ALU/Logic, and the like, may potentially encode these data bits differently, possibly using different data bits included in the instruction format. It is noted that the encoding depicted in FIG. 4 are merely an example and that, in other embodiments, different encodings may be employed.

Reg 307 and Reg 308 may be configured to store the data included in the Rsrc1 303 and Rsrc2 306 fields, respectively. Stage decoder 311 may receive the op1 301 field of fetched instruction 314 and be configured to decode the received field. As described below in more detail, the decoding of op1 301 may indicate if fetched instruction needs to be modified. Alternatively, Stage decoder 311 may determine if fetched instruction 314 is a prefix instruction, which may indicate that a subsequent instruction needs to have dynamic information applied. Stage decoder 311 may also be configured to generate Control signals 312. In various embodiments, Control signals 312 may be used to configured an execution unit to performed the desired operation using the instruction as modified by Transcoder 309.

Transcoder 309 may be configured to modify the op2 304 field of fetched instruction 304 to generate Dynamic op2 information 310 dependent upon results from Stage decoder 311 as well as the op1 301 field of fetched instruction 314. Dynamic op2 information 310 may, along with control signals 312 and the contents of Reg 307 and Reg 308, may be send to a functional unit, such as Execution Unit(s) 230 of the embodiment illustrated in FIG. 2. In some embodiments, Transcoder 309 may be configured to retrieve data from Reg 313 that may be used modify the op2 204 field of fetched instruction 314. The data retrieved from Reg 313 may include a new type or operator that will be included as part of a modified version of fetched instruction 314.

It is noted that the embodiment illustrated in FIG. 3 is merely an example. In other embodiments, different numbers of stages and different configurations of functional stages are possible and contemplated

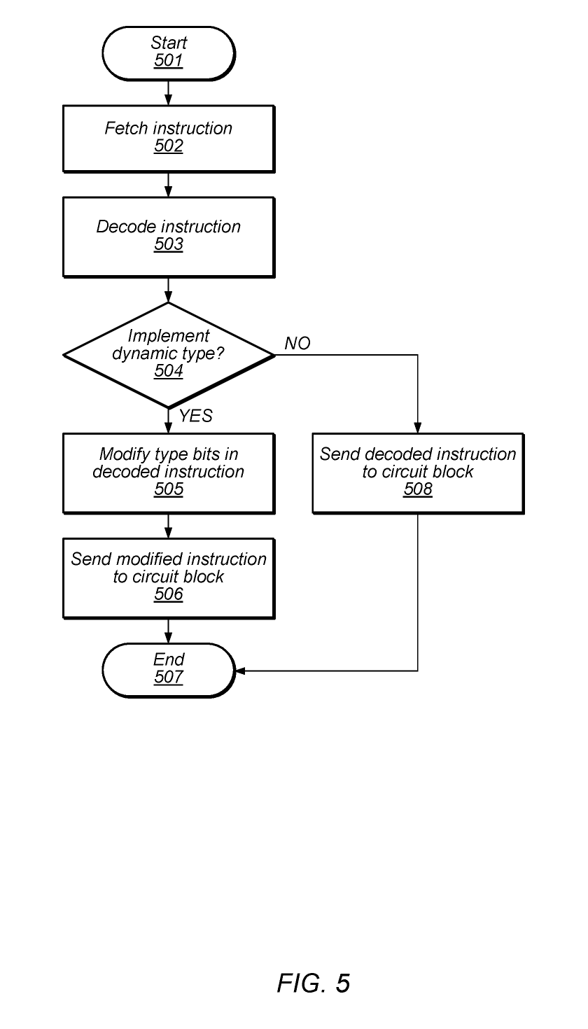

A flow diagram illustrating an embodiment of a method for providing hardware support for dynamic data types is depicted in FIG. 5. Referring collectively to FIG. 2, FIG. 3, and the flow diagram of FIG. 5, the method begins in block 501.

Instruction Fetch Unit 201 may then fetch an instruction (block 502). In some cases, the instruction may be fetched from system memory, such as, e.g., System Memory 130 as illustrated in FIG. 1, while, in other cases, the instruction may be fetched from Instruction Cache 214.

DITU 216 may then decode a portion of the fetched instruction (block 503). In various embodiments, DITU 216 may decode a portion, i.e., a subset of the data bits included in the fetched instruction. For example, as illustrated in FIG. 3, Stage decoder 311 may decode the data bits corresponding to op1 301 of instruction. The method may then depend on the results of the decoding (block 504).

If it is determined that the fetched instruction does not use dynamic types, then the decoded instruction may be sent to Execution unit(s) 230 (block 508). The method may then conclude in block 507.

Alternatively, if it is determined that the fetched instruction employs dynamic types, then Transcoder 309 may then modify the type bits of the fetched instruction (block 505). In some embodiments, the data bits corresponding to opt 301 and op2 304 may be modified. Information supplied by Stage decoder 311 may be used in the process of modifying the aforementioned data bits.

The fetched instruction included the modified type bits, i.e., the modified instruction, may then be sent to Execution unit(s) 230 for execution (block 506). Once the modified instruction has been sent to Execution unit(s) 230, the method may conclude in block 507.

It is noted that the embodiment illustrated in the flow diagram of FIG. 5 is merely an example. In other embodiments, different operations and different orders of operations are possible and contemplated.

Different methods may be employed to identify instructions that use dynamic types. One particular method involves the insertion of a specialized instruction (referred to herein as a “prefix instruction”) into the sequence of instructions included in an application or other piece of software. The prefix instruction may, in various embodiments, serve two purposes. First, the prefix instruction may identify that the instruction following the prefix instruction in the program order will employ dynamic types. Second, execution of the prefix instruction may read information from a register, such as, e.g., register 313 as illustrated in FIG. 3, which will be used to modify type information in the instruction following the prefix instruction. By employing a prefix instruction, any instruction in the ISA of a particular computing system may employ dynamic types.

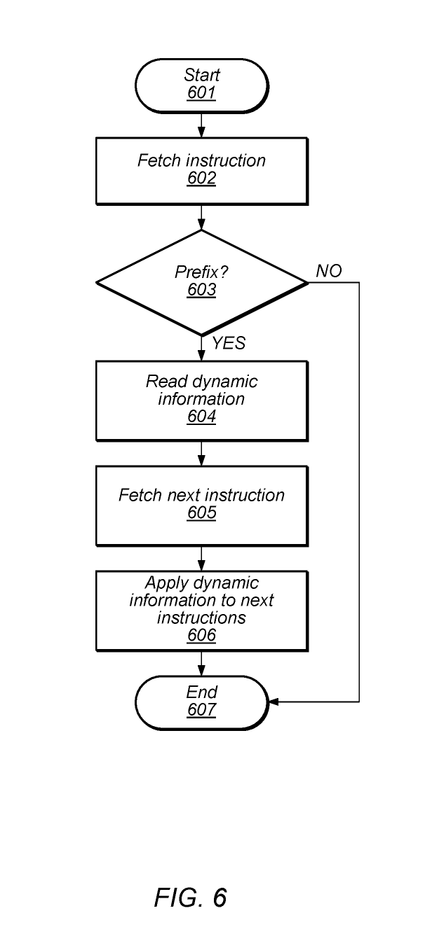

A flow diagram illustrating an embodiment of a method adding a prefix instruction to support dynamic types is depicted. Referring collectively to FIG. 2, FIG. 3, and the flow diagram of FIG. 6, the method begins in block 601. It is noted that when employing prefix instruction, the DITU unit may be moved from initial instruction fetch on the front-end to the post-decode or trace cache instruction fetch points.

Instruction Fetch Unit 201 may then fetch an instruction (block 502). In some cases, the instruction may be fetched from system memory, such as, e.g., System Memory 130 as illustrated in FIG. 1, while, in other cases, the instruction may be fetched from Instruction Cache 214. The method may then depend on whether the fetched instruction is a prefix instruction (block 603). It is noted that prefix instructions may be inserted into the program instructions during compilation in order to identify instructions, which employ dynamic types.

If it is determined that the fetched instruction is not a prefix instruction, then the method may conclude in block 607. Alternatively, if the fetched instruction is a prefix instruction, then dynamic type information may then be read (block 604). In some embodiments, the dynamic type information may be read from a predetermined register. In other embodiments, the prefix instruction may include information specifying one of multiple registers from which the dynamic information is to be retrieved.

Instruction Fetch Unit 201 may then fetch the next instruction in the program order (block 605). Since the previously fetched prefix instruction indicates that the subsequently fetched instruction employs dynamic types, the retrieved dynamic information may then be applied to next instruction (block 606). In various embodiments, one or more subsets of the data bits included in the next instruction may be modified dependent upon the dynamic information. For example, if the next instruction specifies using 8-bit unsigned numbers, the dynamic information may indicate that 32-bit unsigned numbers will be used during execution. Accordingly, the necessary data bits included next instruction may be modified to allow for 32-bit unsigned numbers. With the modification of the next instruction, the method may conclude in block 607.

It is noted that the embodiment illustrated in FIG. 6 is an example. In other embodiments, different arrangements and different operations may be employed.

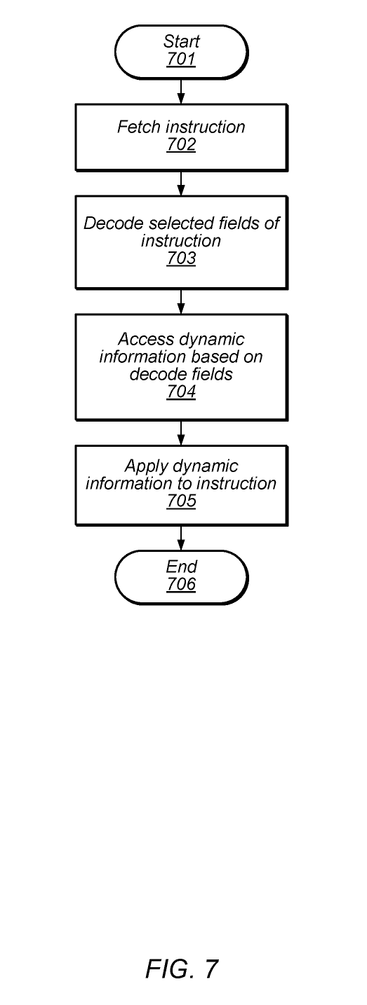

Rather than using a specialized prefix instruction to convey dynamic information and identify instructions that should be modified, additional information may be encoded into individual instructions that allow for the similar functionality. Existing bit fields within an instruction that encode the static data type may, in certain embodiments, be repurposed for encoding information to implement dynamic data types By repurposing such bit field, in such a fashion, changes to the ISA may be avoided. An example of a single instruction method is illustrated in the flow diagram of FIG. 7. Referring collectively to FIG. 2, FIG. 3, and the flow diagram of FIG. 7, the method begins in block 701. When using this single instruction implementation, it is noted that the location of the DITU may be dependent upon how an instruction is decoded once the DITU accesses the repurposed data bits included in the instruction.

Instruction Fetch Unit 201 may then fetch an instruction (block 702). In some cases, the instruction may be fetched from system memory, such as, e.g., System Memory 130 as illustrated in FIG. 1, while, in other cases, the instruction may be fetched from Instruction Cache 214.

Stage decoder 311 may then decode a portion of the fetched instruction (block 703). In some embodiments, Stage decoder 311 may decode a particular field of the fetched instruction, such as, op1 301, for example. The results of the decode may indicate if dynamic information is to be used and may further indicate a particular location, such as, e.g., a particular register, of where the dynamic information is located and may be transmitted to Transcoder 309.

Using the results of the decoding, the dynamic information may then be accessed (block 704). In various embodiments, the dynamic information may be stored in Register 313 or any other suitable location. The dynamic information may include new type information for operands specified in the fetched instruction. For example, operands may be specified as 8-bit signed integers in the fetched instruction, and the dynamic information may indicate that the operands to be used are 16-bit signed integers.

Once the dynamic information has been retrieved, Transcoder 309 may then apply the dynamic information to the fetched instruction (block 705). In some cases, Transcoder 309 may modify one or more data bit fields included in the fetched instruction. For example, Transcoder 309 may modify op1 301 and op2 304 as illustrated in FIG. 3. Once the fetched instruction has been modified, the method may conclude in block 706.

It is noted that the embodiment of the method depicted in the flow diagram of FIG. 7 is merely an example. In other embodiments, different operations and different arrangements of operations are possible and contemplated.

Another approach to implementing dynamic data types involves making use of the capabilities of fully predicated processors. In such implementations, it becomes easy to provide the effects of full predication and enable generic types across different data classes. Common programming cases may require a particular data class of dynamic data type, such as, e.g., integers or floating point values, general types, including user defined types, may also be supported by employing fully predicated instructions.

In some embodiments, using a fully predicated processor to implement dynamic data types may result in an exponential increase in the number of cases of types and operators. By defining a general data type that includes the data class, such as, e.g., integer, floating point, and the like, the number of possible cases may be reduced to just one per execution unit, and a transcoder may observe a dynamic data type that is appropriate for the an instruction currently being decoded and may nullify the instruction. While this may use some issue slots, it may not occupy the core and may, in various embodiments, save power.

It is noted that by modifying an instruction stream at the front-end of a processor, is an efficient method of implementing advance ISA features. Full predication is one or many possible method in which an ISA may be expanded through the approach of instruction modification at time of issue. In other embodiments, dynamic operations may allow bit field instructions to work on dynamic sizes and offsets, or extending the abilities of permute instructions.

While the benefits of dynamically changing type and operator information within a fetched instruction are considerable, making modifications in assembly code. It is possible, however, to create a high-level language front-end that enables the use of dynamic types and operators.

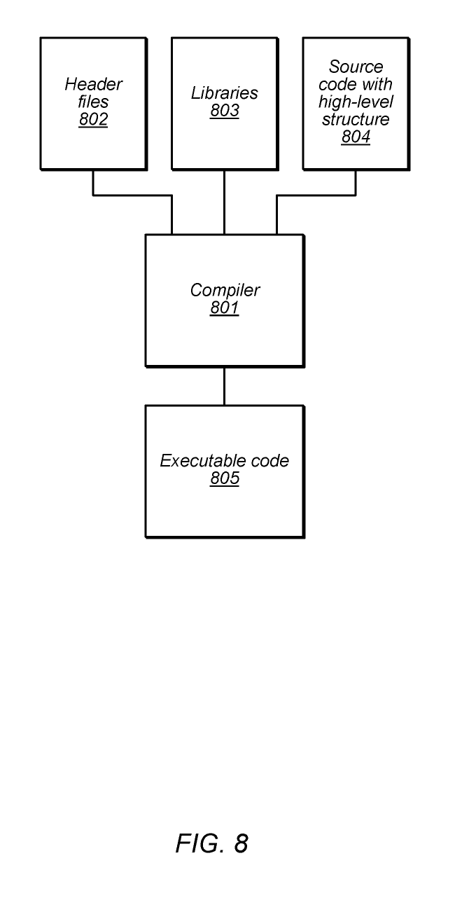

Turning to FIG. 8, a block diagram illustrating high-level language support for dynamic types and operators is illustrated. In the illustrated embodiment, Compiler 801 receives Header files 802, Libraries 803, and Source code 804 in order to generate executable code 805.

Source code 804 may includes high-level language structures as part of modifications to the programming language. Such structures may a dynamically-typed scalar value that may include an 8-byte data type value and 1-byte of dynamic type information. Additionally, the high-level structures may include a dynamically-type array in which a single 1-byte attribute is added to 8-byte scalar values. When Source code 804 is written, the different types may be specified depending on when the dynamic range of values is limited to a single execution class, such as, e.g., dyn_int_array_t, or a generic type, such as, dyn_array_f, for example. To support dynamic operators, macros may be added that may be used to define a desired dynamic operation.

Header files 802 and Libraries 803 may also be modified to support the additional high-level structures such that Compiler 801 will emit the desired assembler instructions. It is noted that supporting dynamic operators and types in this fashion does not require the need to modify Compiler 801. In various embodiments, Header files 802 may define a standard (i.e., processor independent) set of enum values for the types that would be used for translating during compile or defined for different target ISAs.

It is noted that the embodiment illustrated in the block diagram depicted in FIG. 8 is merely an example. In other embodiments, different arrangements of the functional blocks are possible and contemplated.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. An apparatus, comprising:
a decoder circuit configured to:
receive an instruction, wherein the instruction includes a plurality of data bits; and
decode a first subset of the plurality of data bits;
a transcode circuit configured to:
determine if the instruction is to be modified; and
modify a second subset of the plurality of data bits dependent upon the decoding of the first subset of the plurality of data bits in response to a determination that the instruction is to be modified.

2. The apparatus of claim 1, wherein the second subset of the plurality of data bits includes information indicative of a type of an operand associated with the instruction.

3. The apparatus of claim 1, wherein the second subset of the plurality of data bits includes information indicative of an operator associated with the instruction.

4. The apparatus of claim 1, wherein the transcode circuit includes at least one register, and wherein to modify the second subset of the plurality of data bits, the transcode unit is further configured to read data from the at least one register.

5. The apparatus of claim 4, wherein the transcode circuit is further configured to modify the second subset of the plurality of data bits dependent upon the data from the at least one register.

6. The apparatus of claim 1, wherein the transcode circuit is further configured to determine if the instruction is to be modified dependent upon a previously received instruction.

7. A method, comprising:
fetching an a first instruction, wherein the instruction includes a plurality of data bits;
determining if the first instruction is to be modified;
generating a modified instruction in response to determining the instruction is to be modified; and
sending the modified instruction to an execution circuit.

8. The method of claim 7, wherein determining if the first instruction is to be modified includes decoding a first subset of the plurality of data bits.

9. The method of claim 8, wherein generating the modified instruction in response to determining the instruction is to be modified includes modifying a second subset of the plurality of data bits.

10. The method of claim 9, wherein the second subset of the plurality of data bits includes information indicative of a type of an operand associated with the instruction.

11. The method of claim 7, wherein determining if the first instruction is to be modified includes fetching a second instruction, wherein the second instruction is fetched prior to fetching the first instruction.

12. The method of claim 10, further comprising decoding the second instruction and retrieving data from a register dependent upon the decoding of the second instruction.

13. The method of claim 7, wherein generating the modified instruction includes reading data from a register.

14. The method of claim 13, further comprising generating the modified instruction dependent upon the data read from the register.

15. A system, comprising:
a memory configured to store a plurality of instructions; and
a processor configured to:
fetch a first instruction of the plurality of instructions from the memory. wherein the first instruction includes a plurality of data bits;
determine if the first instruction is to be modified;
generate a modified instruction in response to determining the instruction is to be modified; and
execute the modified instruction.

16. The system of claim 15, wherein to determine if the first instruction is to be modified, the processor is further configured to decode a first subset of the plurality of data bits.

17. The system of claim 15, wherein to generate the modified instruction in response to determining the instruction is to be modified, the processor is further configured to modify a second subset of the plurality of data bits.

18. The system of claim 17, wherein the second subset of the plurality of data bits includes information indicative of a type of an operand associated with the instruction.

19. The system of claim 15, wherein to determine if the first instruction is to be modified, the processor is further configured to fetch a second instruction, wherein the second instruction is fetched prior to the first instruction.

20. The system of claim 19, wherein the processor includes at least one register, and wherein the processor is further configured to decode the second instruction and retrieve data from the at least one register dependent upon the decoding of the second instruction.
